(19) United States
(12) Patent Application Publication
(10) Pub. No.: US 2013/0260091 A1
(43) Pub. Date: Oct. 3, 2013

(54) FLIP-OVER DRAWING ACTIVITY PAGE CONSTRUCTION

(71) Applicant: Sylvia Anne Stein, New York, NY (US)

(72) Inventor: Sylvia Anne Stein, New York, NY (US)

(21) Appl. No.: 13/436,988

(22) Filed: Apr. 1, 2012

(51) Int. Cl. B32B 3/10; B42D 5/00

(52) U.S. Cl. 428/131; 281/38

(57) ABSTRACT

A page construction for a creativity activity, or as part of a book, wherein a horizontal page is folded in half along the horizontal axis, exposing panel that designates a specific space for coloring. Once that space is colored, and the panel is flipped to the back, the drawing peeks through a die-cut on the opposite panel. In this way, drawing can appear to be part of a pre-printed illustration on that opposite panel, adding an element of surprise and magic.

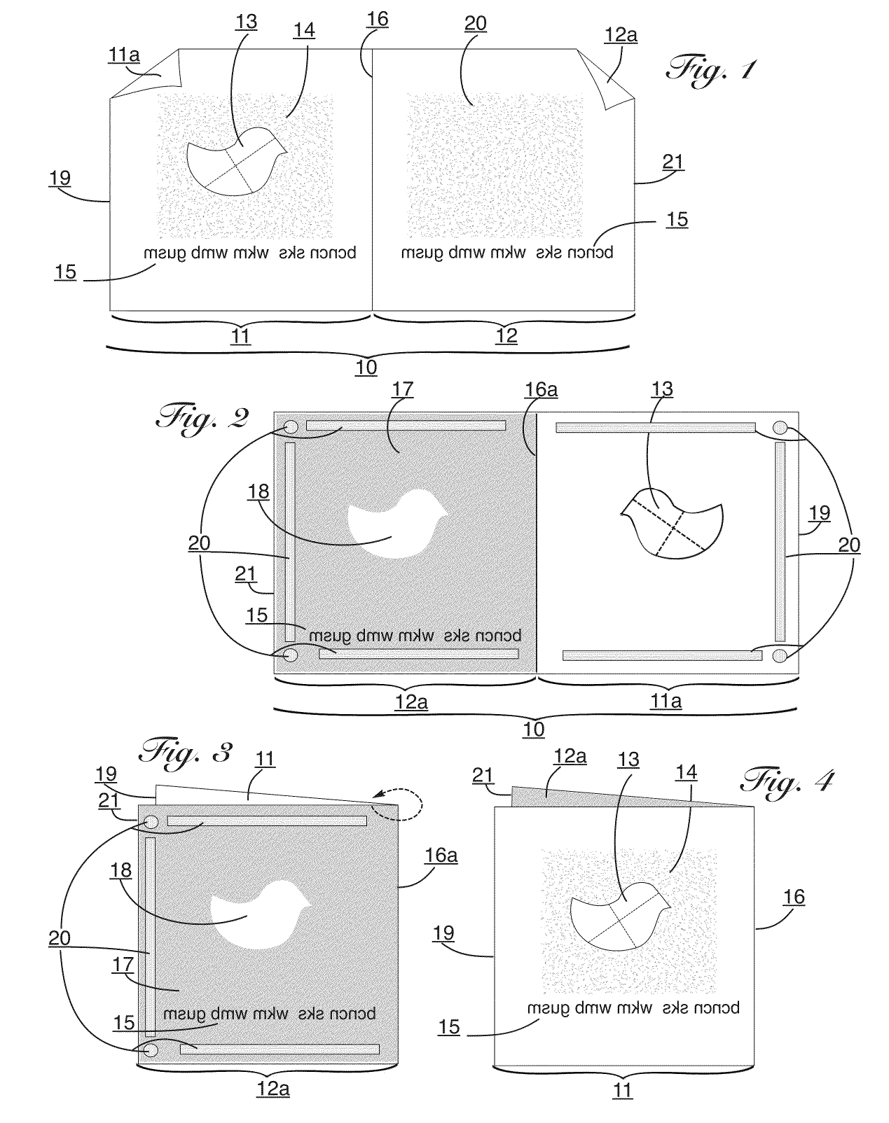

FIG. 1 illustrates side A of the right-folding construction of the flip-over drawing activity page. The horizontal page can be any dimension between 1″ and 24″ height (19, 16, 16a, 21) and 1″ and 24″ width (10) where the horizontal width (10) is longer than the height (19, 16, 16a, 21). The page can be made of paper or board with a thickness between 60 gsm to 500 gsm. Side A contains the vertical external fold line (16) in the center of the horizontal axis (10). The external fold-line (16) delineates two panels of equal size, one on the left (11) and the other on the right (12). The left panel is the die-cut panel (11) and includes one or more die-cut spaces (13) and can include a die-cut illustration (14), which incorporates the die cut space (13). The die cut panel (11) can also contain copy (15). The right panel is the story panel (12) and can include an illustration (20) and, or, copy (15). If this page is included in a bound book, the page attaches to the spine of the book along the left anchor-edge (19).

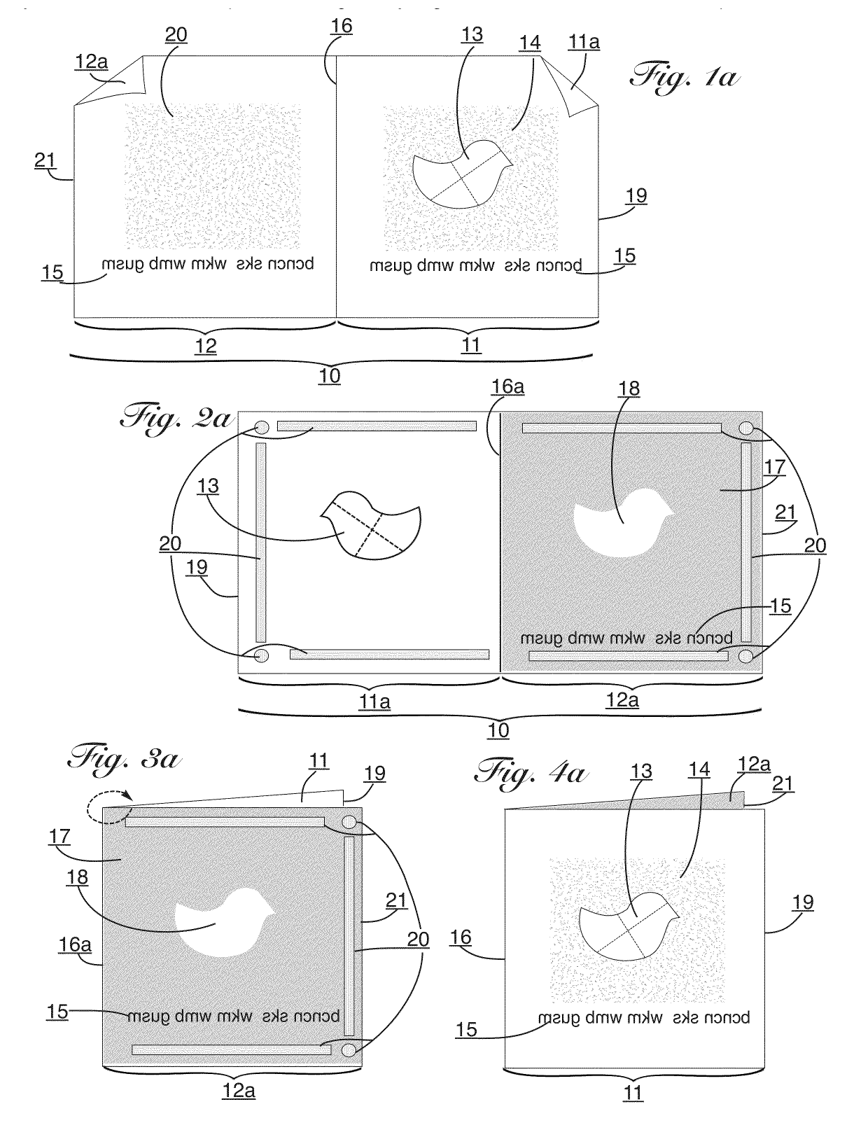

FIG. 2 illustrates side B of the right-folding construction of the flip-over drawing activity page, viewed by turning side A of the page over along the anchor-edge (19), or the free-edge (21). Side B contains the internal vertical fold line (16a) in center of the horizontal axis (10), which delineates two panels of equal size, one on the left (12a) and the other on the right (11a). The left panel is the color-in panel (12a). The color-in panel (12) is a solid panel with no die-cuts, and is printed with a demarcation or mask (17) delineating the color-in-space (18). The color-in space(s) correspond, in size, shape, and location on the page, with the die-cut space(s) (13) in FIG. 1 when the entire page is folded in half along the fold line (16a) and the external-fold line (16) is exposed. The color-in panel (12a) can include illustrations and, or, copy (15). The right panel is the mirror-die-cut panel, which contains the reverse side of the die-cut (13) in the die-cut panel (11). The color-in panel (12a) and, or, the mirror die-cut panel (11a) can include adhesive dots or strips, covered with corresponding peel-away protective dots or strips (20). If this page is included in a bound book, the page attaches to the spine of the book along the right anchor-edge (19).

FIG. 3 illustrates the color-in position of the right-folding construction of the flip-over drawing activity page. The color-in panel (12a), which is printed with a demarcation or mask (17) delineating the color-in space (18), is facing the reader. The page is folded with the internal fold line (16a) facing out, so that the die-cut panel (11) and the story panel (12) are hidden from view, facing each other to either side of external fold line (16). In the color-in position the mirror-die-cut panel (11a) is visible, but is facing away from the reader. If this page is included in a bound book, the page attaches to the spine of the book along the anchor-edge (19). In the color-in position, the child or adult is invited to color or decorate the color-in-space (18).

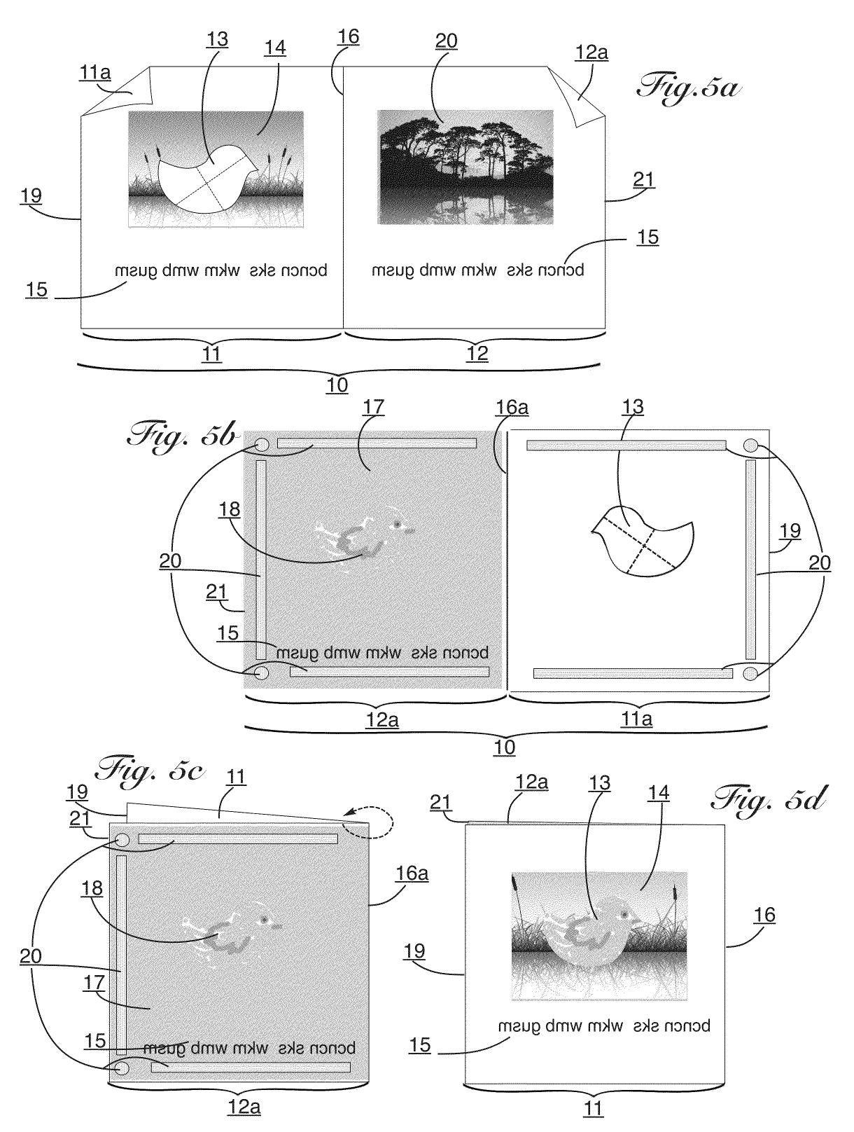

FIG. 4 illustrates the see-though position of the right-folding construction of the flip-over drawing activity page. The page is folded with external fold line (16) facing out, so that the die-cut panel (11) is facing the reader, the color-in panel (12a) and the mirror die-cut panel (11a) are facing each to either side of the internal fold line 16a. In the see-through position, the story panel (12) is visible, but is facing away from the reader. Once folded in the see-through position, the protective dots or strips (20) can be removed revealing the adhesive dots or strips, so that the mirror-die-cut panel (11a) can be adhered to the color-in panel (12a). In this see-through position, the child or adult can view his/her drawing in the color-in space (18) peeking through the die-cut-space (13), juxtaposed with the die-cut-illustration (14). If this page is included in a bound book, the page attaches to the spine of the book along the back, left anchor-edge (19).

FIGS. 1a-4a illustrate the left-folding construction of the drawing activity page. As a result of the left-folding construction, the positions of the die-cut panel (11), the story panel (12), the mirror-die-cut panel (11a) and the color-in panel (12a), relative to each other, are shifted as shown.

FIG. 5(a-d) illustrates the flip-over activity page with illustrations (14, 20), and the color-in space (18) colored in by the child or adult, and the color-in space (18) juxtaposed with the die-cut-space and the die-cut-illustration (14) in the see-through position (FIG. 5d)

Activity books provide ways for children and adults to engage in educational or creative activities. Coloring books provide pre-printed outlines for the child or adult to fill with colors, or decorate with patterns. Stencil coloring books provide overlays with die-cut-spaces. The child or adult places the stencil on top of the coloring page, colors within the die-cut-space, and then removes the stencil.

Various embodiments of this invention provide the effect of a stencil, without a stencil. Further, these embodiments provide the addition of a surprise element to the activity, as well as a foolproof way to juxtapose the drawing created by the child or adult with a preprinted illustration and/or story.

A flip-over drawing activity page is a horizontal piece of paper or board with a vertical fold line (16 & 16a) in the center of the horizontal axis (10) created by lining up an anchor-edge (19) and a free-edge (21). If the flip-over drawing activity page is associated with a book, the anchor-edge (19) is attached to the spine, and the free-edge (21) moves freely.

The flip-over drawing activity page in made up of two sides: side A (FIG. 1, 1a) and side B (FIG. 2, 2a) viewed by turning the page horizontally over the anchor-edge (19) or the free-edge (21).

In the unfolded position, the vertical fold line (16 & 16a) creates two equal sized panels, one on the left and one on the right, on each side of the page, for a total of four panels:
A die-cut panel (11), which can contain a die-cut-illustration (14) with a die-cut (13), or multiple die-cuts. The die-cut is an empty space created when a portion, or portions, of the page removed. The die-cuts are usually associated with the design of the die-cut illustration (14), forming the shape of a distinct part of the die-cut illustration, for example an animal or a flower. The die-cut panel can also include copy (15).
A mirror-die-cut panel (11a), which is the reverse side of the die-cut panel (11). The mirror-die-cut panel contains the same die-cut or multiple die-cuts as panel (11), and may contain illustrations or copy.
A story panel (12), which contains an illustration and or copy, but does not contain any die-cuts.
A color-in panel (12a), which is the reverse side of the story panel (12). The color-in panel is printed with a demarcation or mask (17) delineating a color-in-space (18), or multiple color-in spaces. The demarcation can be a line or shading that defines the area actual color-in space (18) or a space up to 0.25″ beyond the boundary of the color-in space. The mask defines the color-in space, or 0.25″ beyond the color-in space, as negative space by including color around the color-in space, or up to 0.25″ beyond the boundary of the color-in space. The color-in panel (12a) contains no die-cuts. The color-in panel (12a) can include an adhesive dot or strip, or multiple adhesive dots or strips, each covered by removable, protective paper. (20). The color-in-space (18) is a specific shape in a specific location on the page, which corresponds, in size, shape, and location, with the die-cut space(s) (13) in FIGS. 1, la & FIGS. 2, 2a when the page is folded along the fold line (16 & 16a)) such that the reverse-die-cut panel (11a) and the color-in panel (12a) are facing each other.
An external fold line (16) separates the die-cut panel (11) and the story panel (12).
An internal fold line (16a) separates the color-in panel (12a) and the mirror-die-cut panel (11a).

The flip-over drawing activity page can be folded in two positions:
A color-in position (FIGS. 3, 3a, 5c) where the internal fold line (16a) is exposed, and the color-in panel (12a) and the mirror-die-cut panel (11a) are visible.
A see-through position (FIGS. 4, 4a, 5d) where the external fold line (16) is exposed, and the die-cut panel (11) and the story panel (12) are exposed. In the see-through position (FIGS. 4, 4a, 5d), the color-in space(s) (18) line up with the die cut(s) (13) so that the color-in space (18) is visible inside the die-cut(s) (13).

The flip-over drawing activity page can be constructed in two ways:
A right-folding construction (FIGS. 1-4), where side A (FIG. 1) is laid out the die cut panel (11) on the left, and the story panel (12) on the right, separated by the external fold line (16). And side B (FIG. 2) in laid out with the color-in panel (12a) on the left and the mirror-die-cut (11a) on the right, separated by the internal fold line (16a).
A left-folding construction (FIGS. 1a-4a) where side A (FIG. 1a) is laid out with the story panel (12) on the left, and the die-cut panel (11) on the right, separated by the external fold line (16). And side B (FIG. 2a) is laid out with the mirror-die-cut panel (11a) on the left, and the color-in panel (12a) on the right, separated by the internal fold line (16a).
In both the right-folding, and the left-folding constructions, the anchor-edge (19) is associated with the die-cut panel (11) and the minor-die-cut panel (11a).

The child or adult first encounters the flip-over drawing activity page in the color-in position (FIGS. 3, 3a, 5c), with the color-in panel (12a) facing the reader. Once the child or adult has finished coloring in or decorating the color-in-space(s) (18), the free-edge (21) is flipped to the other side, exposing the external fold line (16), and forming the see-though position (FIGS. 4, 4a, 5d). In the see-though position, the adhesive backing dots or strips (20) can be removed, exposing the adhesive dots or strips (20), and the reverse-die-cut panel (11a) and the color-in panel (12a) can be adhered together.

In the see-through position (FIGS. 4, 4a, 5d), the child or adult sees, for the first time, the die-cut panel (11) with the die-cut illustration (14) and the die-cut empty space (13). In the see-though position the previously colored or decorated color-in-space (18) is visible inside the die-cut empty space (13) and juxtaposed with the die-cut illustration (14).

The flip-over drawing activity page can be a single page, not attached to other pages. The flip-over drawing activity page can also be bound in a book, where the page is attached to the spine of the book along the anchor-edge (19).

The flip-over drawing activity page can also be associated with packaging or any paper goods product, such as stationary, postcards, craft projects, or stickers.

Referring now to FIG. 1, there is shown side A of the right-folding construction of the flip-over drawing activity page. The page can be any dimension between 1″ and 24″ height (16) and 1″ and 24″ width (10) where the horizontal width (10) is longer than the height (19, 21). The page can be made of paper or board with a thickness between 60 gsm to 500 gsm. The external fold line (16) is a vertical fold line in the center of the horizontal axis (10). The external fold-line (16) separates two panels of equal size, the die-cut panel (11) on the left and the story panel (12) on the right.

Referring now to FIG. 2 there is shown side B of the right-folding construction of the flip-over drawing activity page. The internal fold line (16a) is a vertical fold line in the center of the horizontal axis (10). The internal fold-line (16a) separates two panels of equal size, the color-in panel (12a) on the left and the mirror die-cut panel (11a) on the right.

Referring now to FIG. 3, there is shown the color-in position of the right-folding construction of the flip-over drawing activity page.

Referring now to FIG. 4, there is shown the see-though position of the right-folding construction of the flip-over drawing activity page.

Referring now to FIG. 1a, there is shown side A of the left-folding construction of the flip-over drawing activity page. The page can be any dimension between 1″ and 24″ height (16) and 1″ and 24″ width (10) where the horizontal width (10) is longer than the height (19, 21). The page can be made of paper or board with a thickness between 60 gsm to 500 gsm. The external fold line (16) is a vertical fold line in the center of the horizontal axis (10). The external fold-line (16) separates two panels of equal size, the story panel (12) on the left, and the die-cut panel (11) on the right.

Referring now to FIG. 2a there is shown side B of the left-folding construction of the flip-over drawing activity page. The internal fold line (16a) is a vertical fold line in the center of the horizontal axis (10). The internal fold-line (16a) separates two panels of equal size, the mirror die-cut panel (11a) on the left and the color-in panel (12a) on the right.

Referring now to FIG. 3a, there is shown the color-in position of the left-folding construction of the flip-over drawing activity page.

Referring now to FIG. 4a, there is shown the see-though position of the left-folding construction of the flip-over drawing activity page.

Referring now to FIG. 5(a-d), there is shown the flip-over activity page with placeholder illustrations (14, 20), and the color-in space (18) colored in by the child or adult, and the color-in space (18) juxtaposed with the die-cut-space and the die-cut-illustration (14) in the see-through position (FIG. 5d)

What is claimed is:

1. A product comprising:
a horizontal paper or board between 1″ and 24″ height and 1″ and 24″ width. and having a thickness between 60 gsm to 500 gsm
wherein the page contains the vertical fold line which divides the horizontal page in half.
wherein one side of the page contains the die-cut panel and the story panel, separated by the external fold line
wherein the other side of the page contains the mirror-die cut and the color-in panel, separated by the internal fold line.

2. the product of claim 1,
wherein the page has a right-folding configuration

3. the product of claim 1,
wherein the page has a left-folding configuration

4. the product of claim 1,
wherein the page is attached to the spine of a book along the anchor-edge

5. the product of claim 1,
wherein the page is incorporated into packaging or a product label.

6. the product of claim 1,
wherein the page is any paper product such as stationary, postcard, stickers or craft project.

7. the product of claim 1,
wherein there are adhesive dots or strips to adhere the mirror die-cut panel to the color-in panel, in the see-though position.
